(19) United States
(12) Patent Application Publication
(10) Pub. No.: US 2021/0130217 A1
(43) Pub. Date: May 6, 2021

(54) GLASS ROLL MANUFACTURING METHOD

(71) Applicant: Nippon Electric Glass Co., Ltd., Shiga (JP)

(72) Inventors: Hiroki MORI, Shiga (JP); Yohei KIRIHATA, Shiga (JP)

(21) Appl. No.: 17/053,188

(22) PCT Filed: Jun. 6, 2019
(86) PCT No.: PCT/JP2019/022517

§ 371 Date: Nov. 5, 2020

(30) Foreign Application Priority Data
Jun. 22, 2018 (JP) 2018-118914

(51) Int. Cl. C03B 21/02; C03B 35/16; B65H 18/10; B65H 20/10; B65H 20/12

(52) U.S. Cl. CPC C03B 21/02; C03B 35/16; B65H 20/12; B65H 20/10; B65H 18/10

(57) ABSTRACT

A method of manufacturing a glass roll includes separating unnecessary portions from a glass ribbon by cutting the glass ribbon along a longitudinal direction while conveying the glass ribbon. The method also includes passing the glass ribbon, from which the unnecessary portions are separated, through a looseness conveyance region on a conveyance path where the glass ribbon is loosened, and taking up the glass ribbon around a roll core at a downstream end of the conveyance path. A suction conveyor is provided between the looseness conveyance region and the downstream end on the conveyance path. While the glass ribbon is conveyed by the suction conveyor, the glass ribbon is tensioned between the suction conveyor and the downstream end on the conveyance path along with taking up the glass ribbon around the roll core.

### TECHNICAL FIELD

The present invention relates to a method of manufacturing a glass roll, which comprises: separating an unnecessary portion of a glass ribbon by cutting the glass ribbon along a longitudinal direction of the glass ribbon while conveying the glass ribbon; and taking up the glass ribbon around a roll core.

### BACKGROUND ART

In recent years, a small thickness and a small weight are demanded for mobile terminals such as smartphones and tablet PCs which are rapidly spread. Thus, in the current condition, there is an increasing demand for reduction in thickness of glass substrates to be incorporated into those terminals. Under such current condition, a glass film which is a glass substrate reduced in thickness as small as that of a film (for example, thickness equal to or smaller than 300 μm) is now developed and manufactured.

In some cases, manufacturing steps for the glass film include a step of manufacturing a glass roll by taking up a glass ribbon, which serves as a base material of the glass roll, into a roll shape. One example of a specific method for performing the above-mentioned step is disclosed in Patent Literature 1.

In the method disclosed in Patent Literature 1, first, a glass ribbon is continuously formed by an overflow down-draw method. Next, the formed glass ribbon is cut along a longitudinal direction thereof while being conveyed. Along with the cutting, unnecessary portions (unnecessary parts including edge portions) located at both ends of the glass ribbon in a width direction of the glass ribbon are separated from an effective portion (part which later becomes a product) located at a center in the width direction. Finally, the glass ribbon formed only of the effective portion is taken up around the roll core, thereby manufacturing the glass roll.

In the method described above, at the time of taking up the glass ribbon, the glass ribbon is conveyed and drawn to a periphery of the roll core under a state in which the glass ribbon is loosened. Thus, a magnitude of tension which acts on a part being taken up is approximately zero. In such a manner, with the method described above, the following disadvantages can be avoided.

When the glass ribbon is drawn to the periphery of the roll core under a state in which the glass ribbon is tensioned, that is, under a state in which tension acts on the glass ribbon, the tension acting on the part being taken up propagates to and act on parts at which the unnecessary portions are being separated. Due to such propagation and action of the tension, quality of cut end portions which are formed along with the separating (cutting) is degraded, with the result that the glass ribbon becomes more liable to break. In contrast, in the method described above, the glass ribbon is drawn to the periphery of the roll core under the state in which the glass ribbon is loosened, thereby being capable of suitably avoiding breakage of the glass ribbon.

### CITATION LIST

### Patent Literature

[PTL 1] JP 2015-174744 A

### SUMMARY OF INVENTION

### Technical Problem

However, although the method disclosed in Patent Literature 1 has the advantages described above, the following drawbacks are present.

Specifically, the glass ribbon is conveyed and drawn to the periphery of the roll core under the state in which the glass ribbon is loosened, and hence, a proceeding direction of the glass ribbon at the time of winding the glass ribbon around the roll core is more liable to be inappropriately inclined with respect to an originally set proceeding direction. As a result, rolling misalignment exceeding a tolerable range is liable to occur in the glass roll to be manufactured. Under such circumstances, there has been awaited establishment of a technology which is capable of not only avoiding breakage of the glass ribbon but also preventing the rolling misalignment of the glass roll.

The present invention which has been made in view of the circumstances described above has a technical object to achieve both avoidance of breakage of a glass ribbon and prevention of rolling misalignment of a glass roll at the time of manufacturing a glass roll by a method comprising: separating an unnecessary portion of a glass ribbon by cutting the glass ribbon along a longitudinal direction of the glass ribbon while conveying the glass ribbon; and taking up the glass ribbon around a roll core.

### Solution to Problem

According to one embodiment of the present invention, which has been devised in order to solve the above-mentioned problem, there is provided a manufacturing method for a glass roll, comprising: separating an unnecessary portion from a glass ribbon by cutting the glass ribbon along a longitudinal direction while conveying the glass ribbon along a conveyance path; causing the glass ribbon, from which the unnecessary portion has been separated, to pass through a looseness conveyance region on the conveyance path under a state in which the glass ribbon is loosened; and taking up the glass ribbon around a roll core at a downstream end of the conveyance path, wherein a conveyance portion configured to convey the glass ribbon toward the downstream end side under a state in which the glass ribbon is fixed and held is provided between the looseness conveyance region and the downstream end on the conveyance path, and wherein, while the glass ribbon is conveyed by the conveyance portion, the glass ribbon is tensioned between the conveyance portion and the downstream end on the conveyance path along with taking up the glass ribbon around the roll core.

In the present method, between the looseness conveyance region and the downstream end on the conveyance path, the conveyance portion conveys the glass ribbon toward the downstream end side under the state in which the glass ribbon is fixed and held. As a result, a part of the glass ribbon being conveyed by the conveyance portion (hereinafter referred to as “part being conveyed”) is brought into the state of being fixed and held by the conveyance portion. Therefore, even when the glass ribbon is tensioned to cause tension to act thereon between the conveyance portion and the downstream end on the conveyance path along with taking up the glass ribbon around the roll core, propagation of the tension from the downstream side toward an upstream side across the part being conveyed can be avoided. Accordingly, in the looseness conveyance region located more on the upstream side than the part being conveyed, the looseness of the glass ribbon can be maintained, and propagation of the above-mentioned tension to parts of the glass ribbon at which an unnecessary portion is being separated can be prevented. Therefore, degradation in the quality of the cut end portions formed on the glass ribbon along with the separation of the unnecessary portion can be prevented, thereby being capable of avoiding breakage of the glass ribbon. Moreover, in the present method, as mentioned above, the glass ribbon is tensioned between the conveyance portion and the downstream end on the conveyance path along with taking up the glass ribbon around the roll core. Accordingly, inappropriate inclination of a proceeding direction at the time of winding the glass ribbon around the roll core with respect to an originally set proceeding direction can be avoided. Therefore, rolling misalignment of a glass roll to be manufactured can be prevented. With the above-mentioned features, according to the present method, both the avoidance of the breakage of the glass ribbon and the prevention of the rolling misalignment of the glass roll can be achieved.

In the above-mentioned method, the conveyance portion may comprise a belt provided to a suction conveyor.

In such a manner, with use of the belt provided to the suction conveyor, the part being conveyed can be fixed and held.

In the above-mentioned method, the conveyance portion may comprise a rotating peripheral portion of a suction roller.

In such a manner, with use of the rotating peripheral portion of the suction roller, the part being conveyed can be fixed and held.

In the above-mentioned method, it is preferred that a surface that is a non-guaranteed surface among front and back surfaces of the glass ribbon be fixed and held on the conveyance portion.

In such a manner, when the conveyance portion conveys the glass ribbon, a stain on a guaranteed surface of the glass ribbon due to contact with the conveyance portion can be avoided.

In the above-mentioned method, the glass ribbon may be cut under a state in which the glass ribbon is laminated on a protection sheet, and the glass ribbon that is in a state of being separated from the protection sheet may be caused to pass through the looseness conveyance region.

In such a manner, with the glass ribbon being laminated on the protection sheet, formation of flaws or the like on the glass ribbon can be avoided as much as possible. Further, when the glass ribbon that is in the state of being separated from the protection sheet is caused to pass through the looseness conveyance region, the operation of causing the conveyance portion to fix and hold the glass ribbon having passed through the region can suitably be performed.

In the above-mentioned method, it is preferred that torque transmission between the roll core and a rotation shaft of a drive source configured to rotate the roll core be performed with use of a friction clutch.

The conveyance speed of the glass ribbon given at the time of being wound around the roll core may inevitably change to be slightly faster or slower. It is practically difficult to perform control of changing the rotation number of the rotation shaft of the drive source in accordance with a minute change in conveyance speed every time such a minute change in conveyance speed occurs. In contrast, when the torque transmission between the roll core and the rotation shaft of the drive source is performed with use of the friction clutch, the above-mentioned minute change in conveyance speed can be managed with slippage that occurs in the friction clutch. Moreover, as a method other than the use of the friction clutch, adjustment of motor rotation torque of the drive source (for example, torque control with use of a servomotor) is also adoptable.

### Advantageous Effects of Invention

According to the present invention, it is possible to avoid breakage of the glass ribbon and prevention of rolling misalignment of the glass roll at the time of manufacturing the glass roll by the method comprising: separating the unnecessary portion of the glass ribbon by cutting the glass ribbon along the longitudinal direction of the glass ribbon while conveying the glass ribbon; and taking up the glass ribbon around the roll core.

### BRIEF DESCRIPTION OF DRAWINGS

FIG. 1 is a side view for illustrating a manufacturing method for a glass roll according to a first embodiment of the present invention.

FIG. 2 is a plan view for illustrating the manufacturing method for a glass roll according to the first embodiment of the present invention.

FIG. 3 is a side view for illustrating a manufacturing method for a glass roll according to a second embodiment of the present invention.

FIG. 4 is a side view for illustrating a manufacturing method for a glass roll according to a third embodiment of the present invention.

### DESCRIPTION OF EMBODIMENTS

Now, with reference to the accompanying drawings, description is made of a manufacturing method for a glass roll according to an embodiment of the present invention.

### First Embodiment

First, description is made of a configuration of a manufacturing apparatus to be used for the manufacturing method for a glass roll according to a first embodiment of the present invention.

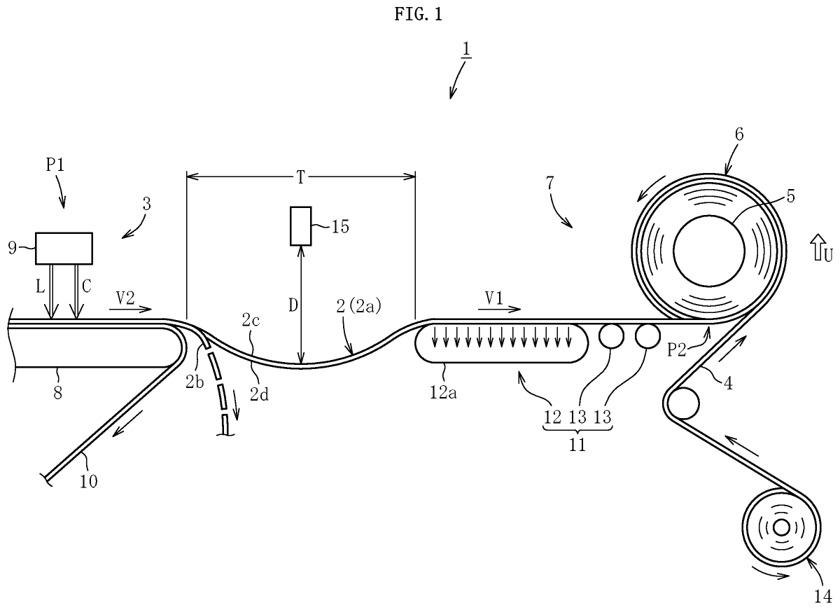

As illustrated in FIG. 1, a manufacturing apparatus 1 comprises a separating mechanism 3 and a take-up mechanism 7. The separating mechanism 3 is configured to separate unnecessary portions 2b (parts which later do not become a product and are to be discarded) of a glass ribbon 2 from an effective portion 2a (part which later becomes a product) of the glass ribbon 2 by cutting the glass ribbon 2 along a longitudinal direction in a cutting region P1 on a conveyance path while conveying the glass ribbon 2. The take-up mechanism 7 is configured to take up the glass ribbon 2 from which the unnecessary portions 2b are separated (glass ribbon 2 formed only of the effective portion 2a) around a roll core 5 under a state in which the glass ribbon 2 is laminated on a band-shaped protection sheet 4 at a downstream end P2 of the conveyance path, thereby producing a glass roll 6.

In the manufacturing apparatus 1, under a state in which the glass ribbon 2 is loosened to protrude downward, the glass ribbon 2 passes through a looseness conveyance region T that is located between the cutting region P1 and the downstream end P2 on the conveyance path.

The glass ribbon 2 subjected to cutting is a glass which is continuously formed by an overflow down-draw method and thereafter is changed in its conveyance direction from a vertically downward direction to a horizontal direction. The glass ribbon 2 comprises the unnecessary portions 2b and the effective portion 2a. The unnecessary portions 2b are located at both ends in a width direction of the glass ribbon 2 (direction perpendicular to the drawing sheet in FIG. 1). The effective portion 2a is located at a center in the width direction. The glass ribbon 2 is formed so as to have a thickness (for example, 300 μm or less) that may give flexibility to the glass ribbon 2. In this embodiment, an upper surface 2c of the glass ribbon 2 is a guaranteed surface (surface that is suitable for being subjected to, for example, film-forming processing later), and a lower surface 2d of the glass ribbon 2 is a non-guaranteed surface. A forming method for the glass ribbon 2 is not limited to the overflow down-draw method, and any other method such as a float method, a slot down-draw method, or a redraw method may be used.

The separating mechanism 3 comprises a conveying device 8 and a cutting device 9. The conveying device 8 is configured to convey the glass ribbon 2 in the cutting region P1. The cutting device 9 is configured to cut the glass ribbon 2 being conveyed.

As the conveying device 8, a belt conveyor configured to convey the glass ribbon 2 in a horizontal posture. As a matter of course, the conveying device 8 is not limited to the belt conveyor, and any other conveyor such as a roller conveyor may be used. Moreover, the conveyance device 8 may comprise a surface table, which is fixedly installed, and a band-shaped sheet (for example, a band-shaped protection sheet 10 described later), which is configured to slide on the surface table.

The band-shaped protection sheet 10 is supplied to a conveyance surface of the conveying device 8 (here, a surface of the belt provided to the belt conveyor). The band-shaped protection sheet 10 is fed toward a downstream side under a state in which the band-shaped protection sheet 10 is laminated on the glass ribbon 2. After that, the band-shaped protection sheet 10 is separated from the glass ribbon 2 and drawn downward from the conveying device 8, thereby separating the band-shaped protection sheet 10 from the conveyance path of the glass ribbon 2. As the band-shaped protection sheet 10, there may be used, for example, a foam resin sheet. With the band-shaped protection sheet 10, a lower surface 2d of the glass ribbon 2 being conveyed on the conveying device 8 is protected.

As the cutting device 9, a laser cutter arranged above the conveying device 8 is used. The laser cutter is configured to radiate a laser L along a boundary line between the effective portion 2a and each of the unnecessary portions 2b of the glass ribbon 2 passing below the laser cutter and spray a coolant C (for example, a mist of water) to parts having been heated along with the radiation.

With the separating mechanism 3 described above, the glass ribbon 2 is continuously cut along the longitudinal direction by a laser cleaving method, to thereby separate the effective portion 2a and each of the unnecessary portions 2b. Any method other than the laser cleaving method, for example, a laser fusing method may be used to separate the effective portion 2a and each of the unnecessary portions 2b.

The unnecessary portion 2b having been separated from the effective portion 2a is separated downward from the conveyance path of the glass ribbon 2 (effective portion 2a), and is cut into a length suitable for discarding and then is discarded. Such cutting for discarding is performed by curving an upper surface 2c side of the unnecessary portion 2b into a protruding shape to apply bending stress thereto. In this embodiment, in order to facilitate cutting of the unnecessary portion 2b, a scratching member (not shown) is used to scratch an end portion of the unnecessary portion 2b from the upper surface 2c side in the width direction at every length suitable for discarding. Accordingly, the unnecessary portion 2b can more easily be cut (broken) with the scratch as a starting point. As the scratching member, there may be used, for example, a diamond grinder, a diamond chip, or abrasive paper.

The take-up mechanism 7 comprises a conveying device 11 and the roll core 5. The conveying device 11 is configured to convey the glass ribbon 2 in a horizontal posture. The roll core 5 is configured to take up the glass ribbon 2 having been conveyed from the conveying device 11.

The conveying device 11 is arranged between the looseness conveyance region T and the downstream end P2 on the conveyance path. The conveying device 11 comprises a suction conveyor 12 and a plurality of conveyance rollers 13.

The suction conveyor 12 comprises a belt 12a serving as a conveyance portion configured to convey the glass ribbon 2 (effective portion 2a) toward the downstream end P2 side under a state in which the glass ribbon 2 is fixed and held. The term. “being fixed and held” means that, during conveyance of the glass ribbon 2 by the suction conveyor 12, both the belt 12a and the part of the glass ribbon 2 being conveyed do not move relative to each other. That is, it means that both of a surface of the belt 12a and the lower surface 2d of the part being conveyed do not move relative to each other.

The belt 12a has a large number of suction holes (not shown) passing through the belt 12a in a thickness direction. Moreover, on an inner peripheral side of the belt 12a, there is arranged a negative-pressure generating mechanism (not shown) connected to, for example, a vacuum pump. The negative-pressure generating mechanism generates a negative pressure on the glass ribbon 2 through the suction holes, to thereby fix and hold the lower surface 2d of the glass ribbon 2 on the surface of the belt 12a, which serves as a conveyance surface, through suction. Accordingly, the glass ribbon 2 that is in the state of being sucked on the belt 12a is conveyed toward the downstream side of the conveyance path at the same conveyance speed as a feeding speed V1 by the belt 12a. The belt 12a may be configured to suck the entire width of the glass ribbon 2 in the width direction or may be configured to suck only a part of the glass ribbon 2 in the width direction.

The plurality of conveyance rollers 13 are free rollers arranged along the conveyance path of the glass ribbon 2. As a matter of course, some or all of the plurality of conveyance rollers 13 may be drive rollers.

The roll core 5 is rotatable about an axial center extending along the width direction of the glass ribbon 2. The roll core 5 is configured to take up the glass ribbon 2, which has been conveyed by the conveying device 11 to the downstream end P2 of the conveyance path, with the upper surface 2c side of the glass ribbon 2 placed on an inner side. Moreover, as indicated by the arrow U, the roll core 5 is capable of gradually moving upward while taking up the glass ribbon 2. With this configuration, even when a diameter of the glass roll 6 gradually increases along with the progress of the take-up action, a part of the glass ribbon 2 extending from the conveyance rollers 13 toward the roll core 5 is maintained in a horizontal posture.

The rotation number of the roll core 5 is set to such a rotation number that, along with taking up the glass ribbon 2 around the roll core 5, the part of the glass ribbon 2 that is located between the suction conveyor 12 and the downstream end P2 is tensioned. As the diameter of the glass roll 6 gradually increases, the rotation number of the roll core 5 is gradually reduced. Accordingly, regardless of the diameter of the glass roll 6, the rotation circumferential speed of the glass roll 6 is maintained constant.

The band-shaped protection sheet 4 is supplied from the lower surface 2d side to the glass ribbon 2 having been taken up around the roll core 5. As the band-shaped protection sheet 4, there may be used, for example, a resin sheet (for example, PET film). The band-shaped protection sheet 4 is continuously drawn out along with the rotation of the roll core 5 from a sheet roll 14 arranged below the roll core 5. The band-shaped protection sheet 4 is wound around the roll core 5 in a tensioned state (state in which tension acts on the band-shaped protection sheet 4).

In the looseness conveyance region T, above the conveyance path of the glass ribbon 2, there is arranged a detector 15 configured to detect a mutual distance D between the detector 15 and the upper surface 2c of the glass ribbon 2 (effective portion 2a). In this embodiment, an ultrasonic sensor is used as the detector 15. The mutual distance D detected by the detector 15 is transmitted as a signal to the suction conveyor 12. The suction conveyor 12 having received the signal is capable of adjusting the feeding speed V1 by the belt 12a so that the mutual distance D is set to be constant. That is, the suction conveyor 12 functions also as a looseness controller configured to control the degree of looseness of the glass ribbon 2 in the looseness conveyance region T.

Specifically, a magnitude of the mutual distance D is determined based on the feeding speed V1 by the suction conveyor 12 and a feeding speed V2 by the conveying device 8. Here, the feeding speed V2 by the conveying device 8 is equal to a forming speed of the glass ribbon 2. The degree of looseness of the glass ribbon 2 protruding downward is adjusted by setting the feeding speed V1 by the suction conveyor 12 to be faster or slower than the feeding speed V2, thereby adjusting the mutual distance D to be constant.

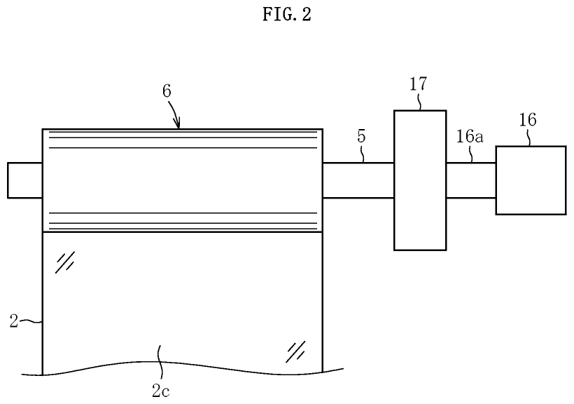

As illustrated in FIG. 2, torque transmission between the roll core 5 and the drive source 16 (for example, a motor), which is configured to rotate the roll core 5, is performed with use of a friction clutch 17 interposed therebetween. The rotation number of a rotation shaft 16a of the drive source 16 is higher than the rotation number of the roll core 5. Accordingly, slippage occurs in the friction clutch 17 due to the difference in rotation number between the roll core 5 and the rotation shaft 16a of the drive source 16. As a result, in the case in which the suction conveyor 12 functions as the above-mentioned looseness controller, even when the feeding speed V1 by the suction conveyor 12 becomes faster or slower, the roll core 5 can be rotated with a constant torque because the drive source 16 is coupled to the friction clutch 17. Moreover, as a method other than the use of the friction clutch 17, adjustment of motor rotation torque of the drive source 16 (for example, torque control with use of a servomotor) is also adoptable.

Next, description is made of a manufacturing method for a glass roll according to the first embodiment of the present invention with use of the manufacturing apparatus 1 described above, and actions and effects thereof.

As illustrated in FIG. 1, when the glass ribbon 2 having been formed is conveyed to the cutting region P1 on the conveyance path, the effective portion 2a and the unnecessary portions 2b of the glass ribbon 2 that is in the state of being laminated on the band-shaped protection sheet 10 on the conveying device 8 are continuously separated. The unnecessary portions 2b having been separated are discarded. The glass ribbon 2 (effective portion 2a) having been separated is conveyed from the conveying device 8 toward the downstream side and separated from the band-shaped protection sheet 10. After that, the glass ribbon 2 is caused to pass through the looseness conveyance region T and transferred to the suction conveyor 12.

In such a manner, the glass ribbon 2 is conveyed between the looseness conveyance region T and the downstream end P2 by the suction conveyor 12. The suction conveyor 12 conveys the glass ribbon 2 toward the downstream side under the state in which the glass ribbon 2 is fixed and held. As a result, even when the glass ribbon 2 is tensioned (tension acts on the glass ribbon 2) between the suction conveyor 12 and the downstream end P2, propagation of the tension from the downstream side toward the upstream side across the part of the glass ribbon 2 being conveyed by the suction conveyor 12 can be avoided. Accordingly, the looseness of the glass ribbon 2 in the looseness conveyance region T can be maintained, and propagation of the above-mentioned tension to parts of the glass ribbon 2 at which the unnecessary portions 2b are being separated can be prevented. Therefore, degradation in the quality of the cut end portions formed on the glass ribbon 2 along with the separation of the unnecessary portions 2b can be prevented, thereby being capable of avoiding breakage of the glass ribbon 2.

The glass ribbon 2 having been conveyed from the suction conveyor 12 is fed toward the downstream side by the plurality of conveyance rollers 13 and thereafter is taken up around the roll core 5 at the downstream end P2. At this time, the glass ribbon 2 is tensioned between the suction conveyor 12 and the downstream end P2. Accordingly, inappropriate inclination of a proceeding direction of the glass ribbon 2 at the time of winding the glass ribbon 2 around the roll core 5 with respect to an originally set proceeding direction can be avoided. Therefore, rolling misalignment of the glass roll 6 to be manufactured can be prevented. After the operation of taking up the glass ribbon 2 having a desired length around the roll core 5 is completed, manufacture of the glass roll 6 is completed.

Now, a method of manufacturing the glass roll according to each of other embodiments of the present invention is described. In the description of the other embodiments, elements that are substantially the same as those described in the above-mentioned first embodiment are denoted by the same reference symbols. Overlapping description thereof is omitted, and only the differences from the first embodiment are described.

### Second Embodiment

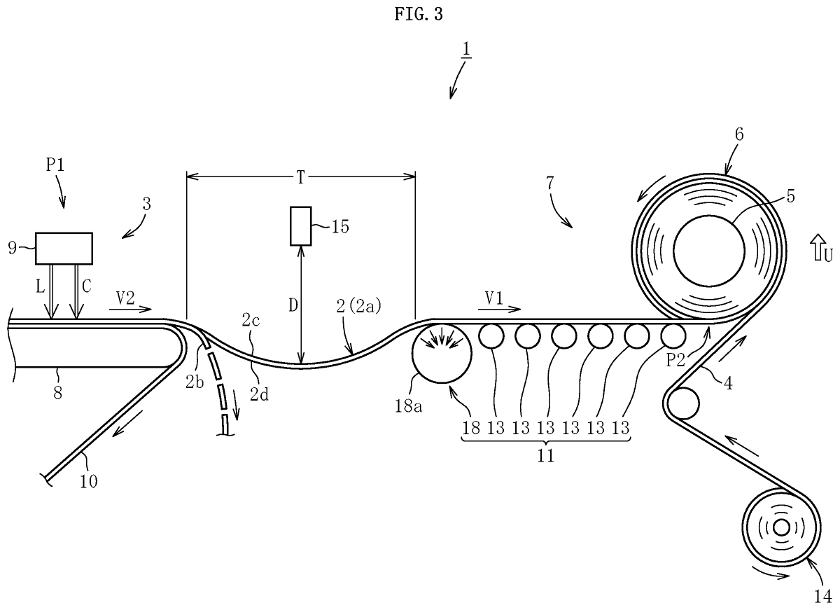

As illustrated in FIG. 3, a manufacturing method for a glass roll according to a second embodiment is different from the above-mentioned first embodiment in that a suction roller 18 is arranged in place of the suction conveyor 12 to form the conveyance portion with a rotating peripheral portion 18a of the suction roller 18.

The rotating peripheral portion 18a of the suction roller 18 has a large number of suction holes (not shown) each having a hole axis extending in a radial direction of the suction roller 18. Moreover, a negative-pressure generating mechanism (not shown) connected to, for example, a vacuum pump is provided inside the suction roller 18. The negative-pressure generating mechanism generates a negative pressure on the glass ribbon 2 through the suction holes, to thereby fix and hold the lower surface 2d of the glass ribbon 2 on an outer peripheral surface of the suction roller 18, which serves as a conveyance surface, through suction. Accordingly, the glass ribbon 2 that is in the state of being sucked on the suction roller 18 is conveyed toward the downstream side of the conveyance path at the same conveyance speed as the rotation circumferential speed of the rotating peripheral portion 18a.

### Third Embodiment

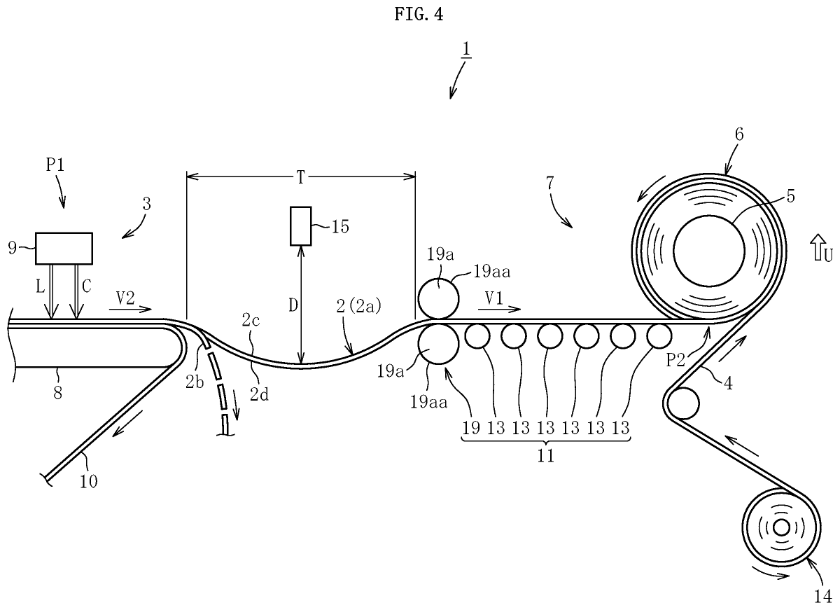

As illustrated in FIG. 4, a manufacturing method for a glass roll according to a third embodiment is different from the above-mentioned first embodiment in that a nip roller 19 is arranged in place of the suction conveyor 12 to form the conveyance portion with respective rotating peripheral portions 19aa of a pair of nipping rollers 19a and 19a forming the nip roller 19.

The pair of nipping rollers 19a and 19a are capable of fixing and holding the glass ribbon 2 by nipping the glass ribbon 2 in the thickness direction. Accordingly, the glass ribbon 2 that is in the state of being nipped by the nipping rollers 19a and 19a is conveyed toward the downstream side of the conveyance path at the same conveyance speed as the rotation circumferential speed of the respective rotating peripheral portions 19aa of the nipping rollers 19a and 19a.

The manufacturing method for a glass roll according to the present invention is not limited to the mode described in the above-mentioned embodiments. For example, in the above-mentioned embodiments, the glass roll is manufactured by separating the unnecessary portions from the glass ribbon, which is continuously formed by the overflow down-draw method, and thereafter taking up the glass ribbon around the roll core. However, the present invention is not limited to this method. The present invention is applicable also to a case of manufacturing a glass roll with use of a roll-to-roll mode, that is, by separating unnecessary portions from a glass ribbon, which is continuously taken out from a first roll core, and thereafter taking up the glass roll again around a second roll core.

Moreover, in the embodiments described above, the glass ribbon is taken up around the roll core with the upper surface side of the glass ribbon placed on the inner side roll core, and the band-shaped protection sheet is supplied from the lower surface side. However, the present invention is not limited to this method. The glass ribbon may be taken up around the roll core with the lower surface side of the glass ribbon placed on the inner side, and the band-shaped protection sheet may be supplied from the upper surface side.

### REFERENCE SIGNS LIST

2 glass ribbon
2b unnecessary portion
2c upper surface
2d lower surface
5 roll core
6 glass roll
10 band-shaped protection sheet
12 suction conveyor
12a belt
16 drive source
16a rotation shaft
17 friction clutch
18 suction roller
18a rotating peripheral portion
T looseness conveyance region
P2 downstream end

1. A manufacturing method for a glass roll, comprising:
separating an unnecessary portion from a glass ribbon by cutting the glass ribbon along a longitudinal direction while conveying the glass ribbon along a conveyance path;
causing the glass ribbon, from which the unnecessary portion has been separated, to pass through a looseness conveyance region on the conveyance path under a state in which the glass ribbon is loosened; and
taking up the glass ribbon around a roll core at a downstream end of the conveyance path,
wherein a conveyance portion configured to convey the glass ribbon toward the downstream end side under a state in which the glass ribbon is fixed and held is provided between the looseness conveyance region and the downstream end on the conveyance path, and
wherein, while the glass ribbon is conveyed by the conveyance portion, the glass ribbon is tensioned between the conveyance portion and the downstream end on the conveyance path along with taking up the glass ribbon around the roll core.

2. The manufacturing method for a glass roll according to claim 1, wherein the conveyance portion comprises a belt provided to a suction conveyor.

3. The manufacturing method for a glass roll according to claim 1, wherein the conveyance portion comprises a rotating peripheral portion of a suction roller.

4. The manufacturing method for a glass roll according to claim 1, wherein a surface that is a non-guaranteed surface among front and back surfaces of the glass ribbon is fixed and held on the conveyance portion.

5. The manufacturing method for a glass roll according to claim 1,
wherein the glass ribbon is cut under a state in which the glass ribbon is laminated on a protection sheet, and
wherein the glass ribbon that is in a state of being separated from the protection sheet is caused to pass through the looseness conveyance region.

6. The manufacturing method for a glass roll according to claim 1, wherein torque transmission between the roll core and a rotation shaft of a drive source configured to rotate the roll core is performed with use of a friction clutch.
